(19) United States
(12) Patent Application Publication
(10) Pub. No.: US 2016/0371698 A1
(43) Pub. Date: Dec. 22, 2016

(54) Systems and Methods for Authenticating Business Partners, in Connection With Requests by the Partners for Products and/or Services

(71) Applicant: MASTERCARD INTERNATIONAL INCORPORATED, Purchase, NY (US)

(72) Inventors: Gary Adler, Teaneck, NJ (US); Michael Miralles Cimatu, Bel Air, MD (US); John Baker, Brooklyn, NY (US); Richard D. D'Erizans, Pleasantville, NY (US); Jennifer L. Donovan, Wentzville, MO (US); Yansheng Wei, Wildwood, MO (US); Sara E. Fiebiger, Ellisville, MO (US); Sheila R. Panus, O'Fallon, MO (US); James Maus, St. Charles, MO (US)

(21) Appl. No.: 15/184,660

(22) Filed: Jun. 16, 2016

Related U.S. Application Data
(60) Provisional application No. 62/180,251, filed on Jun. 16, 2015.

(51) Int. Cl. G06Q 20/40

(52) U.S. Cl. CPC G06Q 20/4016; G06Q 20/4014

(57) ABSTRACT

Systems and methods for use in authenticating business partners, in connection with requests by the partners for various products and/or services, are disclosed. An exemplary method generally includes receiving a request from a business partner for a product and/or a service where the product and/or service relates, for example, at least partly, to transaction data, or other data. The method also generally includes assigning a risk score to the business partner, comparing the risk score assigned to the business partner to a sensitivity threshold associated with the requested product and/or service, and distributing the product and/or service to the business partner, when the risk score satisfies the sensitivity threshold.

### CROSS-REFERENCE TO RELATED APPLICATION

This application claims the benefit of, and priority to, U.S. Provisional Application No. 62/180,251 filed on Jun. 16, 2015. The entire disclosure of the above application is incorporated herein by reference.

### FIELD

The present disclosure generally relates to systems and methods for authenticating business partners, in connection with requests by the partners for various products and/or services, and prior to distributing the products and/or services to the partners.

### BACKGROUND

This section provides background information related to the present disclosure which is not necessarily prior art.

Payment devices are used by consumers to perform numerous different transactions including, for example, purchasing products and/or services from merchants, etc. Generally, transaction data is compiled based on the transactions. The transaction data may be aggregated, culled, divided, and/or analyzed in a number of different ways to gain insight into and/or awareness of transaction trends for one or more merchants or consumers, of characteristics of processes involved in payment transactions (e.g., fraud detection tools, etc.), etc. The insight into and/or awareness of these features are known to result in products and/or services, which may be provided to participants in the payment transactions, such as acquirers, issuers, or merchants, whereby the participants may develop processes to improve and/or protect their businesses.

### DRAWINGS

The drawings described herein are for illustrative purposes only of selected embodiments and not all possible implementations, and are not intended to limit the scope of the present disclosure.

FIG. 1 is an exemplary system for use in authenticating a business partner of a payment network in connection with a request by the partner for a product and/or service from the payment network;

FIG. 2 is a block diagram of an exemplary computing device, suitable for use in the system of FIG. 1;

FIG. 3 is a flowchart of an exemplary method for authenticating a business partner of a payment network in connection with a request by the partner for a product and/or service from the payment network, which can be implemented via the system of FIG. 1; and

FIG. 4 is a flow diagram of the data components, related to risk scores, which can be utilized in performing the method of FIG. 3.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Transaction data is often compiled by payment networks, for example, in connection with payment device transactions by consumers. The transaction data may be aggregated, culled, divided, and/or analyzed in a number of different ways to gain insight into and/or awareness of transaction trends for the consumers, for one or more merchants involved in the transactions, etc., or to gain insight into and/or awareness of characteristics of processes involved in the transactions (e.g., for use in fraud detection tools, etc.), etc. This insight and/or awareness is often provided, by the payment networks, in connection with products and/or services (including access to particular information) to business partners such as acquirers, issuers, or merchants, whereby the partners use and/or access the information in various different ways to improve and/or protect their businesses. However, because the various products and/or services provided by the payment networks are based, at least in part, on the transaction data, and because the business partners may be unknown to the payment networks, with only certain publically verifiable data available about the partners, and because the business partners may be present in one or more different countries, care must be taken in distributing the products and/or services to the business partners, to help ensure that the same are not delivered to improper recipients (as defined by various regulations, for example), or to unintended, inappropriate, or even, illegal partners, etc.

The systems and methods herein can be used by the payment networks to authenticate the partners, prior to distributing the products and/or services to the partners, to help ensure that the partners are the intended partners requesting the products and/or services and are legitimate, and that the products and/or services will be used in a legal, ethical, etc., manner. In particular, a product and/or service may be requested by a business partner (existing or new) of a payment network. Separately, or in response to the request, the partner is assigned a risk score, which is based on information known about the partner, and which can be indicative of whether the partner is real and existing as it has presented itself to the payment network. The product and/or service is also assigned a sensitivity threshold (or tier), which is indicative of the sensitivity or kind of transaction data included in, or accessed by, the product and/or service, for example. If the risk score for the partner satisfies the sensitivity threshold for the product and/or service, the partner is authenticated and the product and/or service may be delivered to the partner. But if the risk score does not satisfy the sensitivity threshold, the product and/or service is denied or the request is transferred for manual intervention.

It should be appreciated that the methods and systems herein are applicable to entities other than payment networks and, as such, should not be considered as limited to payment networks. For example, various businesses, that are not payment networks as used herein, may implement aspects of the present disclosure to authenticate business partners, in connection with requests by the partners for various products and/or services, and prior to distributing the products and/or services to the partners.

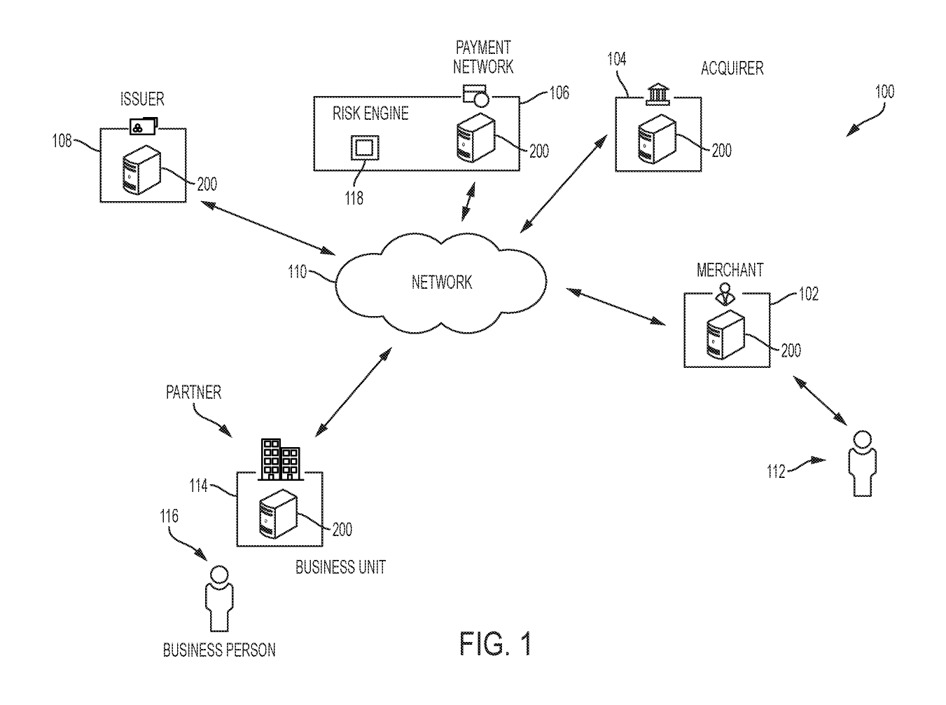

FIG. 1 illustrates an exemplary system 100, in which the one or more aspects of the present disclosure may be implemented. Although parts of the system 100 are presented in one arrangement, other embodiments may include the same or different parts arranged otherwise, depending, for example, on authorization processes for payment device transactions, arrangements of business partners, etc.

The illustrated system 100 generally includes a merchant 102, an acquirer 104, a payment network 106, and an issuer 108, each coupled to (and in communication with) network 110. Again, while the system 100 is described in connection with the payment network 106, it should be appreciated that features of the system 100 are equally applicable to (and can be implemented in or by) entities other than the payment network 106 (e.g., the merchant 102, other businesses, etc.).

The network 110 of the system 100 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated parts, or even combinations thereof. In one example, network 110 includes multiple networks, where different ones of the multiple networks are accessible to different ones of the illustrated parts in FIG. 1. For example, the acquirer 104, the payment network 106, and the issuer 108 may be connected via a private payment transaction network, and the merchant 102 may be connected to the acquirer 104 through a public network, such as the Internet.

Generally in the system, the merchant 102, the acquirer 104, the payment network 106, and the issuer 108 cooperate, in response to a purchasing entity 112 (e.g., a purchase by the purchasing entity), to complete a payment device transaction. The purchasing entity 112 may include a consumer such as, for example, a purchaser, an institutional purchaser, a professional group, a business, or any other entity that purchases goods or services, etc., from the merchant 102. In the exemplary embodiment, the purchasing entity 112 initiates the transaction by presenting a payment device, such as a credit card, a debit card, a pre-paid card, a payment token, a payment tag, a pass, another device used to provide an account number (e.g., a mobile phone, a tablet, etc.) etc., to the merchant 102.

In a card transaction by the purchasing entity 112, for example, the merchant 102 reads the card and communicates an account number and an amount of the purchase to the acquirer 104 to determine whether the card is in good standing and whether there is sufficient credit/funds to complete the transaction. The acquirer 104, in turn, communicates with the issuer 108, through the payment network 106, for authorization to complete the transaction. If the issuer 108 accepts the transaction, an authorization is provided back to the merchant 102 and the merchant 102 completes the transaction. The credit line or funds of the purchasing entity 112, depending on the type of payment account, is then decreased by the amount of the purchase, and the charge is posted to the account associated with the card. The transaction is later settled by and between the merchant 102 and the acquirer 104 (in accordance with a settlement arrangement, etc.), and by and between the acquirer 104 and the issuer 108 (in accordance with another settlement arrangement, etc.). Certain accounts, such as debit accounts, may further include the use of a personal identification number (PIN) authorization and more rapid posting of the charge to the account associated with the card, etc.

Transaction data is generated, collected, and stored as part of the above interactions among the merchant 102, the acquirer 104, the payment network 106, the issuer 108, and the purchasing entity 112. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104, and/or the issuer 108 may store the transaction data, or part thereof, in memory, or transaction data may be transmitted between entities of system 100, as used or needed. The transaction data includes, for example, payment account numbers, amounts of transactions, merchant IDs, merchant category codes, dates/times of transactions, products purchased and related descriptions or identifiers, products refunded, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108. Further, transaction data, unrelated to a particular payment account, may be collected by a variety of techniques, and similarly stored with the system 100.

In various exemplary embodiments, purchasing entities involved in the different transactions herein agree to legal terms associated with their payment accounts, for example, during enrollment in their accounts, etc. In so doing, the purchasing entities may agree, for example, to allow merchants, issuers of the payment accounts, payment networks, etc., to use data collected during enrollment and/or collected in connection with processing the transactions, subsequently for one or more of the different purposes described herein.

In addition in the system 100, the payment network 106 generates a variety of different products and/or services from/based on the transaction data described above. The products and/or services may be generated based on various different analytical processes, depending on a particular focus of the products and/or services. Various partners of the payment network 106 (e.g., business unit 114, the merchant 102, the acquirer 104, the issuer 108, other partners, etc.) may then request the products and/or services for subsequent use, for example, to improve business operations, etc. In one example, a fraud protection product may seek to identify patterns suggesting fraudulent behavior or individual accounts associated with fraudulent transactions, etc. Or, a consultative white paper product may provide recommendations to business partners related to marketing and/or sales strategies. Or, a product may include particular transaction data that can be used to identify and evaluate merchant competition based on similarities of purchases between different payment accounts. Additionally, a product may include transaction data for a particular merchant, analyzed relative to a variety of data (including transaction data for other competing merchants), to determine if marketing, promotional, or other incentive programs have been effective, as expected, for example. Further products and/or services, such as location detection products and/or services, merchant services, electronic walled acceptance products and/or services, etc., based on transaction data, may be generated and provided to partners, by the payment network 106, by agreement.

Separately in the system 100, the products and/or services, offered by the payment network 106, are assigned sensitivity scores or thresholds, which are generally indicative of the sensitivity of transaction data, or other information, contained and/or accessed by the products and/or services. For example, a fraud detection product, which contains, for example, specific payment account information, may be determined to have a generally high threshold of sensitivity (e.g., a sensitivity score of 90 on a scale of 0-100, etc.), while a marketing product indicative of market size in a particular region/merchant category code (MCC) may have a generally median threshold of sensitivity (e.g., a sensitivity score of 60 on a scale of 0-100, etc.), and while a consultative white paper product containing only general payment account statistics for use in marketing and/or sales strategies may have a generally low threshold of sensitivity (e.g., a sensitivity score of 10 on a scale of 0-100, etc.).

Also in the system 100, the products and/or services offered by the payment network 106 are placed within different tiers of sensitivity, based on the assigned sensitivity scores. The tiers may be identified as desired, for example, as low, low-medium, medium, medium-high, and high, or numerically as 1, 2, 3, 4, or 5 (or by other designations). Regardless of designation, each of the tiers corresponds to a particular sensitivity score, or range of sensitivity scores (e.g., 0-10, 11-30, 31-60, 61-80, and 81-100, or other range, etc.). It should be appreciated that any different number of tiers and/or scores (or ranges of scores) may be employed, depending, for example, on the disparate sensitivity of data included in the particular products and/or services at the issuer 108, the potential use of the products and/or services, etc. In this exemplary embodiment, through use of the tiers, potential risk associated with the different products and/or services, i.e., of providing access to the products and/or services to unintended entities, can quickly and easily be recognized by the payment network 106 and users associated therewith, based on the assigned tier, without having to review particular details of the products and/or services.

Further, in this exemplary embodiment, a threshold is assigned, by the payment network 106, as the products and/or services are created, or later, potentially depending on, for example, the particular transaction data included in or used by the products and/or services, or otherwise. This sensitivity threshold is often assigned according to one or more manual process, potentially depending on business rules, or automatically, based on, for example, the transaction data associated therewith (e.g., included therein, or accessed thereby, etc.). The sensitivity threshold for the products and/or services may further be updated or refreshed, periodically, or intermittently, depending on different changes to the products and/or services, or the transaction data associated therewith. Further, the system 100 may employ one or more processes to provide rules and/or control to audit the sensitivity thresholds, or tiers, for the products and/or services periodically, or intermittently, to ensure the transaction data associated therewith still justifies the sensitivity thresholds, or tiers, assigned to the products and/or services.

With continued reference to FIG. 1, the business unit 114 is provided to seek to purchase or otherwise transact with the payment network 106 for purchase and/or use of one or more products and/or services generated or offered by the payment network 106, based at least in part on transaction data (as described above). A business person 116 is also illustrated in FIG. 1, in association with the business unit 114. In general, the business person 116 contacts and/or communicates with the payment network 106, on behalf of the business unit 114, to purchase or otherwise acquire the one or more products and/or services from the payment network. 106. The business person 116 may be an owner of the business unit 114, or may be otherwise affiliated therewith or representative thereof. The business unit 114 and the business person 116 are referred to herein, collectively, as a partner or business partner (of the payment network 106).

The business unit 114 is illustrated as a separate entity in FIG. 1. However, it should be appreciated that the business unit 114 is often one or more merchants, acquirers, or issuers in the system (such as one or more of the merchant 102, the acquirer 104, and the issuer 108). In addition, in some embodiments, the business unit 114 may even include a consumer, such as the purchasing entity 112. In general, the business unit 114 often includes one or more of the entities participating in a payment account transaction, which would seek to use and/or rely on the products and/or services generated by the payment network 106 based on the transaction data (or other data). In at least one embodiment, however, the business unit 114 is a different entity, not involved in a payment account transactions in the system 100.

While only one merchant 102, one acquirer 104, one payment network 106, one issuer 108, one purchasing entity 112, one business unit 114 and one business person 116 are illustrated in FIG. 1 (for ease of reference), it should be appreciated that a variety of other embodiments may include multiple ones of these entities in various combinations and, in some of these embodiments, hundreds or thousands of certain ones of these entities.

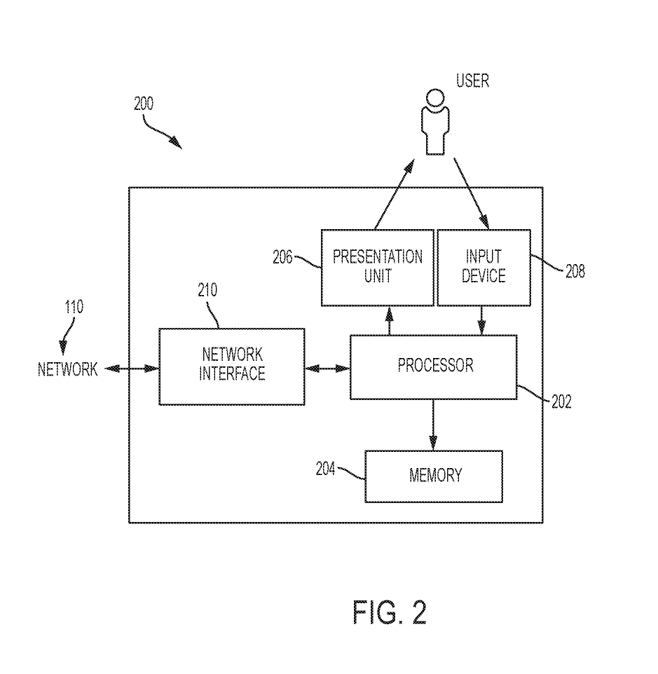

FIG. 2 illustrates an exemplary computing device 200 that can be used in the system 100. The computing device 200 may include, for example, one or more servers, workstations, personal computers, laptops, tablets, smartphones, point of sale (POS) terminals, etc. In addition, the computing device 200 may include a single computing device, or it may include multiple computing devices located in close proximity, or multiple computing devices distributed over a geographic region, so long as the computing devices are specifically configured to function as described herein.

In the exemplary embodiment of FIG. 1, each of the merchant 102, the acquirer 104, the payment network 106, the issuer 108, and the business unit 114 are illustrated as including, or being implemented in, computing device 200, coupled to the network 110. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, risk scores (or tiers), sensitivity factors or thresholds (or tiers) for various products and/or services, business unit profiles, business person profiles, regulations, and/or other types of data suitable for use as described herein. Furthermore, in various embodiments, computer-executable instructions may be stored in the memory 204 for execution by the processor 202 to cause the processor 202 to perform one or more of the various operations described herein, such that the memory 204 is a physical, tangible, and non-transitory computer readable storage media. It should be appreciated that the memory 204 may include a variety of different memories, each implemented in one or more of the functions or processes described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., background inquiries, etc.), either visually or audibly to a user, for example, the purchasing entity 112, the business person 116, etc. It should be further appreciated that various interfaces (e.g., application interfaces, webpages, etc.) may be displayed at computing device 200, and in particular at presentation unit 206, to display information, such as, for example, risk scores (or tiers), sensitivity factors or thresholds (or tiers) for various products and/or services, requests for products and/or services, inquiries to business units/persons, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 also includes an input device 208 that receives inputs from the user (i.e., user inputs) such as, for example, a transaction request from the purchasing entity 112, a product/service request from the business person 116, etc., or inputs from other computing devices, for example, in connection with assigning sensitivity scores to products and/or services, generating risk scores for business units/persons, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces (including the network interface 210) incorporated into or with the processor 202.

Referring again to FIG. 1, the system 100, and in particular, the payment network 106, includes a risk engine 118. Generally, because the various products and/or services provided by the payment network 106 to the business unit 114 (and to other partners) are based, at least in part, on transaction data, the payment network 106 includes the risk engine 118 to authenticate the business unit 114, or assess a risk associated with the business unit 114 (and the corresponding business person 116), prior to providing access to a particular product and/or service to the business unit 114. The risk is determined by the risk engine 118. In particular, the risk engine 118 is configured, often by computer executable instructions, to assign a risk score to the business unit 114 (or other partner), and then to determine, based on the risk score, whether the business unit 114 is permitted to access and/or purchase the product and/or service.

The risk engine 118 may be considered a computing device, consistent with computing device 200, or the risk engine 118 may be associated with the computing device 200 of the payment network 106. It should be appreciated that, in other embodiments, the risk engine 118 may be a standalone entity (and thus a separate computing device), or may be included with other entities either shown or not shown in the system 100, or in systems not relating to or including payment networks, etc.

Generally, upon a request for a particular product and/or service by the business unit 114, the risk engine 118 investigates each of the business unit 114, the business person 116, and the association between the business unit 114 and the business person 116. The risk engine 118 may employ a variety of different risk models, and/or may access a variety of different rules and/or regulations (e.g., U.S. trade regulations, etc.) or third-party data structures (e.g., Dun & Bradstreet, LexisNexis, etc.) in investigating risk associated with the business unit 114. Based on the investigation, which often incorporates regulatory restrictions, the risk engine 118 is configured to assign the risk score to the business unit 114. Then, the risk engine 118 is configured to determine, based on the risk score and one or more thresholds associated with the particular product and/or service requested by the business unit 114, whether to permit or deny the request.

In subsequent requests by the business unit 114 for the same or different products and/or services from the payment network 106, the risk engine 118 may automatically assign the same risk score to the business unit 114 (without further determination). Or, the risk engine 118 may calculate a new (or updated) risk score. Further, the risk engine 118 may update the risk score for the business unit 114 as desired, for example, at particular intervals (e.g., regular or irregular, etc.).

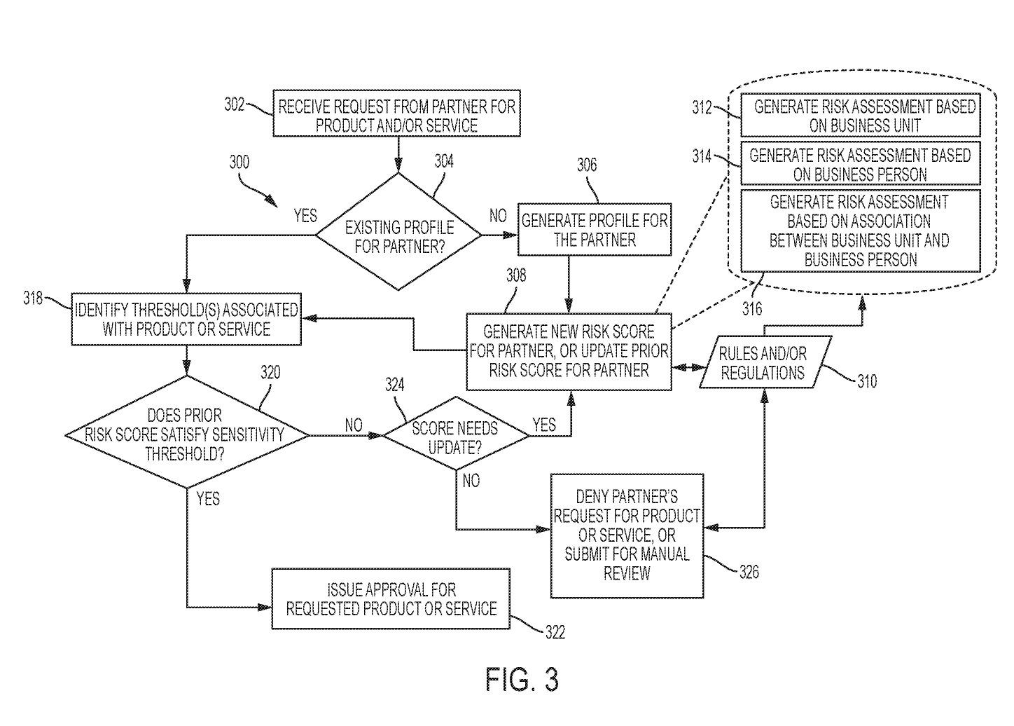

FIG. 3 illustrates an exemplary method 300 for authenticating a business partner in connection with a request by the partner for a product and/or service from a payment network. The exemplary method 300 is described as implemented in the risk engine 118 of the system 100 (as included in the payment network 106), and in connection with the business unit 114 and the business person 116. However, the method 300 is not limited to the system 100, and, as such, may be implemented in other entities of the system 100 or in other systems. Further, for purposes of illustration, the exemplary method 300 is described herein with reference to the computing device 200. The methods herein should not be understood to be limited to the exemplary system 100 or the exemplary computing device 200, and the systems and the computing devices herein should not be understood to be limited to the exemplary method 300. Moreover, and as previously stated, it should be appreciated that, in other embodiments, the risk engine 118 may be a standalone entity, or may be included with other entities, such that the method may be implemented in the risk engine 118 via the other entities (which may or may not be related to payment networks).

With reference to FIG. 3, at 302, the risk engine 118 receives a request from the business unit 114/business person 116 (i.e., a partner as shown in FIG. 3), via the payment network 106, for a product and/or service provided by the payment network 106. The product and/or service identified in the request may be related to any of the products and/or services described above, which are constructed or based, at least in part, on transaction data generated in the system 100. The request may be received by the risk engine 118 as a general inquiry to the payment network 106 for the product and/or service, or it may be received as part of a partner on-boarding process through which the business unit 114 may be attempting to create a business relationship with the payment network 106 (beyond the requested product and/or service).

Upon receiving the request, the risk engine 118 determines, at 304, if the business unit 114 is an existing partner of the payment network 106 and has an existing partner profile (e.g., from a prior request, from a prior on-boarding process, etc.). If the business unit 114 does not have an existing profile, the risk engine 118 (in this exemplary embodiment) generates a partner profile for the business unit 114, at 306. In doing so, the risk engine 118 gathers information from the business unit 114, such as the identity (e.g., official business name, doing-business-as names, etc.), contact information (e.g., street address, city, postal code, country, phone numbers, email address, etc.), business website addresses, business structure, a tax filing identification, MCC for the business unit 114, etc. The same or similar information is also gathered for the business person 116 associated with the business unit 114, which may be included as part of the partner profile for the business unit 114 or which may be used to generate a separate partner profile for the business person 116. The business person may or may not be the same individual making the actual request for the product and/or service. The collected information is included, by the risk engine 118, in the partner profile and stored, for example, in memory 204 of the computing device 200 associated with the payment network 106 (or associated with the risk engine 118).

After the partner profile is generated, at 306, the risk engine 118 generates a risk score for the partner, at 308. The manner in which the risk score is generated may vary between several embodiments of the method 300 described herein.

The risk engine 118 generates the risk score based on various rules and regulations, as retrieved at 310, regarding limitations on relationships with particular businesses (e.g., government regulations, etc.). The various rules and regulations used in generating the risk score, at 308, are accessed, by the risk engine 118, from appropriate data structures, for example, in memory 204 of the computing device 200 associated with the payment network 106, or associated with other entities (e.g., regulatory entities, etc.). The rules may include, for example, trade limitations imposed on various countries (e.g., as administered and enforced by the Office of Foreign Assets Control (OFAC), etc.), rules relating to sanction lists and/or watch lists of particular entities or individuals, other suitable rules, etc. Further, the regulations may include, for example, government regulations, which halt or enable transactions of businesses or information with businesses located in certain countries (e.g., embargoed countries, etc.). As an example, when the payment network 106 is located in Country A and generates, collects and stores transaction data based on transactions in Country A, regulations in Country A may provide (or allow) business with and/or exports to a partner in Country B. In such an example, the risk engine 118 accounts for the regulation by assigning a low risk score to the partner, based, at least in part, on the partner being located in Country B. It should be appreciated that various other rules and/or regulations (governmental and/or otherwise) may impact the risk of providing products and/or services to a business partner, which may be employed by the risk engine 118, in this and/or other method embodiments.

Also in the exemplary embodiment, in generating the risk score, the risk engine 118 may optionally (as indicated by the dotted lines) take into account various risk assessments of the business unit 114 and/or business person 116. As such, as part of generating the risk score, at 308, the risk engine 118 may also (separately or in combination) generate a risk assessment for the business unit 114, at 312, generate a risk assessment for the business person 116, at 314, and generate a risk assessment based on the association between the business unit 114 and the business person 116 at 316.

It should be appreciated that the risk assessments, generated at 312-316, while optional in the illustrated embodiment, may be combined in other embodiments in various different manners with the rules and regulations, accessed at 310, or otherwise. In addition, one or more of the risk assessments, generated at 312-316, may be omitted in still other embodiments. Further, the rules and regulations, accessed at 310, may be considered by the risk engine 118 directly in generating the risk score, at 308, and by the risk engine 118 in generating the individual assessments, at 312-316.

In connection with generating the risk assessments for the business unit 114, at 312, the risk engine 118 may gather and assess information about the business unit 114 and/or business person 116 from (or confirm information received from the business unit 114 during generation of the profile (at 306), based on) a variety of sources such as, for example, third-party business information sources (e.g., Dun & Bradstreet, LexisNexis, etc.), governmental sources (e.g., business registration entities, etc.), publication sources (e.g., newspapers, magazines, other periodicals, etc.), legal sources (e.g., litigation records, court records, etc.), etc. In addition, the risk engine 118 may employ different investigation techniques and/or consult different sources (internally to payment network 106 and/or externally), either automatically or with user assistance, depending on, for example, the country in which the business unit 114 is located and/or doing business. Further, the risk engine 118 may also rely on any past experience or relationship between payment network 106 and the business unit 114 in the assessments. For example, if the payment network 106 and business unit 114 are currently partners, and have been partners for one year, two years, or 15 years, etc., the risk assessment for the business unit 114 may be affected by the historical relationship, in various examples.

In connection with generating the risk assessment for the business person 116, at 314, the risk engine 118 may similarly gather and assess information about the business person 116 from (or confirm information received from the business person 116 during generation of the profile (at 306), based on) a variety of sources, such as for example, business information sources (e.g., Dun & Bradstreet, LexisNexis, etc.), governmental sources (e.g., business registration entities, etc.), publication sources (e.g., newspapers, magazines, other periodicals, etc.), and legal sources (e.g., litigation records, court records, etc.), etc. The risk engine 118 may further utilize historical information about the business person 116 in generating the assessment (e.g., prior requests submitted by the business person 116 to the payment network 106, etc.). Again, the risk engine 118 may also employ different investigation techniques and/or consult different sources (internally to payment network 106 and/or externally), either automatically, or with user assistance, depending on, for example, the country in which the business person 116 resides, etc.

In connection with generating the risk assessment for the association between the business unit 114 and the business person 116, at 316, the risk engine 118 operates to confirm that an association, or relationship, exists between the business unit 114 and the business person 116. For example, the risk engine 118 investigates if the business person 116 has authority to act on behalf of the business unit 114, etc. Thus, while a business unit 114 may be determined to be a low risk, and a business person 116 may also be determined to be a low risk, it is possible that an insufficient association exists between the two. A resulting risk score may then be generally high, based on the lack of association.

Once the risk assessments are generated, at 312-316, the risk engine 118 combines the assessments, also taking into account the rules and regulations, accessed at 310, as described above, to generate the risk score, at 308. The risk score is then stored, by the risk engine 118, for example, in memory 204 of the computing device 200 associated with the payment network 106, etc., as part of the partner profile for the business unit 114. Other factors may also (or alternatively) be used in connection with generating the risk score of the business unit 114 including, for example, product team strategy, regional input, etc.

It should be appreciated that the risk assessments (and, in various aspects, the ultimate risk score) are generated (and assigned) by the risk engine 118 when the business unit 114 provides information to the payment network 106 (and risk engine 118) in connection with creating (or updating) a partner profile for the business unit 114. The risk engine 118 then maps the collected information to give the risk score. As such, the risk engine 118 can create a risk profile through the assessment process (which, in some embodiments, further includes challenging the business unit 114 with various questions etc.).

Example risk scores are shown in Table 1, as calculated for Merchants A, B, and C (and taking into account exemplary risk assessments for the business unit (e.g., as generated at 312 in the method, etc.), the business person (e.g., as generated at 314 in the method, etc.), and the association between the business unit and the business person (e.g., as generated at 316 in the method, etc.), etc.). The Merchants A-C are also assigned to risk tiers in Table 1, based on the risk scores, where, in this example, Tier 1 includes risk scores ranging from 0 to 33; Tier 2 includes risk scores ranging from 34 to 66; and Tier 3 includes risk scores ranging from 67 to 100.

TABLE 1

| | Business | Individual | Business | | |
|---|---|---|---|---|---|
| | Overall | Overall | Association | Risk Score | Tier |
| Merchant A | 20 | 10 | 5 | 95 | 1 |
| Merchant B | 24 | 56 | 5 | 55 | 2 |
| Merchant C | 66 | 33 | 5 | 33 | 3 |

With continued reference to FIG. 3, separately in the method 300, the risk engine 118 identifies, at 318, a threshold associated with the product and/or service included in the request from the business unit 114. In particular, the risk engine 118 accesses a product/service lookup table, or other structure stored, for example, in memory 204 of the computing device 200 associated with the payment network 106, to identify a sensitivity threshold for the identified product and/or service. Table 2 illustrates example sensitivity thresholds and tiers for three products, Product 1-3, offered by the payment network 106. In this example, Tier 1 includes sensitivity threshold values ranging from 0 to 33; Tier 2 includes sensitivity threshold values ranging from 34 to 66; and Tier 3 includes sensitivity threshold values ranging from 67 to 100.

TABLE 2

| | Sensitivity Threshold | Sensitivity Tier |
|---|---|---|
| Product 1 | 80 | 3 |
| Product 2 | 20 | 1 |
| Product 3 | 55 | 2 |

The risk engine 118 then determines, at 320, if the risk score for the business unit 114 satisfies the sensitivity threshold for the requested product and/or service. In the method 300, if the business unit's risk score exceeds the sensitivity threshold for the product and/or service (i.e., satisfies the sensitivity threshold), the risk engine 118 issues an approval for the product and/or service, at 322, upon which the payment network 106 will distribute or otherwise make available the product and/or service to the business unit 114 (potentially depending on, or subject to, additional qualification and conditions set by the payment network 106, or others). With reference to Tables 1 and 2, for example, based on this determination, Product 1 is available to Merchant A, but not to Merchants B and C, when requests are received by Merchants A, B, and C for Product 1. In other embodiments, risk scores may satisfy sensitivity thresholds when the risk scores are less than the thresholds. In still other embodiments, risk scores may satisfy sensitivity thresholds when the risk scores and the thresholds are classified in the same or similar tiers, etc.

If the risk score for the business unit 114 does not satisfy the sensitivity threshold for the requested product and/or service, at 320, the risk engine 118 instead determines, at 324, if the risk score for the business unit 114 needs to be updated.

Specifically, for example, if a partner profile for the business unit 114 existed, at 304, the risk engine 118 accesses and retrieves a prior risk score for the business unit 114, from the partner profile, and employs the prior risk score, at 320, to determine if the risk score satisfies the sensitivity threshold for the requested product and/or service. If the business unit's prior risk score satisfies the sensitivity threshold for the product and/or service, the risk engine 118 issues an approval for the product and/or service, at 322. Alternatively, if the business unit's prior risk score does not satisfy the sensitivity threshold (e.g., is less than the sensitivity threshold, etc.), the risk engine 118 determines, at 324, if a new or updated risk score should be generated. For example, in the method 300, if the prior risk score was generated over a year ago, the risk engine 118 will determine, at 324, that a new risk score should be generated (at 308), as additional information may be available to the risk engine 118 to generate a different risk score for the business unit 114. It should be appreciated that time frames other than one year may be used by the risk engine 118, in other embodiments, in determining whether or not to update prior risk scores that fail to satisfy thresholds for particular products and/or services.

Conversely, if the risk engine 118 determines, at 324, that no update is needed for the business unit's prior risk score (e.g., the prior risk score was generated within the past 2 months, etc.), the risk engine 118 denies the partner's request for the product and/or service, at 326, or submits the request for manual review. The determination of whether to deny the request, or to submit the request for manual review is based on the rules, again accessed by the risk engine 118 at 310, which may indicate a variety of business reasons, often specific to the particular product and/or service (like sensitivity thresholds, for example), etc. For example, a fraud service may warrant further manual review, while a white paper on some topic may not. It should be appreciated that these and other actions, at 326, may be employed depending on the particular product and/or service requested, the relationship, if any, with the business partner, the business condition associated therewith, etc.

Further, in the method 300, determining whether or not to update the business unit's prior risk score, at 324, is dependent on receiving a subsequent request by the business unit 114 for a product and/or service from the payment network 106. Additionally, or alternatively, in other embodiments, the risk engine 118 may update a prior risk score, for example, generated for the business unit 114, at a regular or irregular interval, independent of a subsequent request for a product and/or service by the business unit 114. For example, risk scores for one, some, or all business partners of the payment network 106 may be updated at desired intervals such as, without limitation, every six months, every year, every two years, etc. In these embodiments, the intervals at which the risk scores are updated may depend, for example, on the country in which the business partners are located, changes in volume of business with the business partners, and/or other additional indicators of risk for the business partners (or the business persons associated therewith, etc.), etc.

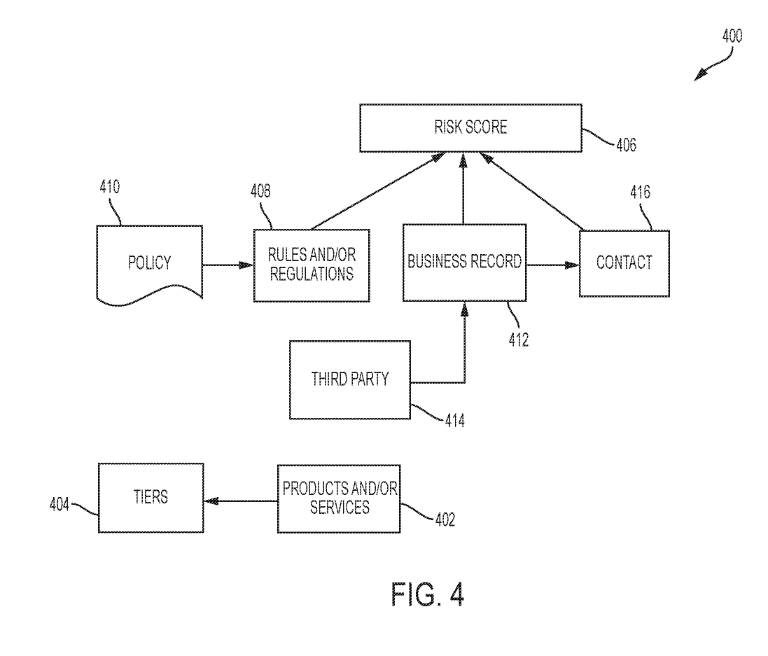

FIG. 4 illustrates an exemplary flow diagram 400 of data associated with the methods herein, and in particular, suitable for implementation in connection with the method 300. In the flow diagram 400, products and/or services 402, for example, made available by the payment network 106, are assigned tiers 404 based on sensitivity scores associated therewith.

Separately in the flow diagram 400, the risk score 406 for the business unit 114, for example, is based on a combination of rules 408, business records 412 of the business unit 114, and contact 416 associated with the business unit 114. The rules 408, for example, are based on a variety of sources, including policies 410 associated with the payment network 106, i.e., the provider of the products and/or services 402. The policies 410 may be related to public relations, data security, business purposes, etc. Additionally, the rules 408, as mentioned above, may be based on regulations imposed by a government agency, an industry authority, or other entity associated with the payment network 106 and/or a group in which the payment network 106 is a member participant, etc. The business records 412 of the business unit 114 are generally available from one or more third parties 414, for example, a secretary of state, or other sources. The contact 416 associated with the business unit 114 may include general inquiries or inquiries related to one or more business records. In particular, as part of the investigation into the business unit 114, for example, the provider may contact the business unit 114, and specifically a person other than the business person 116, to inquire about the business unit 114. Such personal contact may be valuable in assessing whether or not the business unit 114 is what it purports to be, and whether the business person 116 is who he/she purports to be.

The combination of the data components 408, 412, and 416 in the flow diagram 400, as illustrated in FIG. 4, yields the risk score 406, which is then compared, by the risk engine 118, or person associated with the payment network 106, to the tiers 404 of the products and/or services 402 to determine whether they should be distributed.

In this manner, in the systems and methods herein, the risk engine 118 permits the payment network 106 to authenticate the business unit 114, and other existing or potential business partners, to ensure the risk of providing the products and/or services to the business unit 114 (or other business partner) is acceptable. Specifically, the systems and methods herein provide a mechanism by which the payment network 106 (or other provider of products and/or services) may determine if the business unit 114 (or other business partner or potential business partner) is a real business and exists according to the information it has provided (e.g., is located as indicated, etc.), and that the business person 116 is who they say they are, and further that the business person 116 is in association with the business unit 114 as described or purported. If the business unit 114, business person 116, and association therebetween is authenticated, the payment network 106, for example, may more aptly judge risks associated with the business unit 114 and provide various products and/or services thereto, based on sensitivity scores associated with the products and/or services, and whether the information actually known about the business unit 114 warrants distribution of the products and/or services to the business partner.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a request from a partner for a product and/or a service; (b) assigning a risk score to the partner; (c) comparing the risk score assigned to the business partner to a sensitivity threshold associated with the requested product and/or service, as an assurance that distributing the requested product and/or service to the business partner is acceptable; and (d) distributing the product and/or service to the business partner, when the risk score satisfies the sensitivity threshold.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for authenticating a business partner prior to distributing a product and/or a service to the business partner, the method comprising:
receiving a request from a business partner for a product and/or a service;
assigning, by a computing device, a risk score to the business partner;
comparing, by the computing device, the risk score assigned to the business partner to a sensitivity threshold associated with the requested product and/or service, as an assurance that distributing the requested product and/or service to the business partner is acceptable; and
distributing the product and/or service to the business partner, when the risk score satisfies the sensitivity threshold.

2. The method of claim 1, wherein assigning a risk score to the business partner includes:
assessing a business unit associated with the business partner;
assessing a business person associated with the business partner; and/or
assessing an association between the business unit and the business person.

3. The method of claim 2, wherein assigning a risk score to the business partner further includes assigning the risk score based on at least one rule and/or regulation implicated by a location associated with the business partner.

4. The method of claim 3, wherein the business partner is selected from a group consisting of an issuer, an acquirer, a merchant, and a consumer; and
wherein the product and/or the service, requested by the business partner, relates at least partly to transaction data.

5. The method of claim 1, further comprising denying the request for the product and/or service to the business partner, when the risk score fails to satisfy the sensitivity threshold.

6. The method of claim 1, further comprising referring the request for manual review, when the risk score fails to satisfy the sensitivity threshold.

7. The method of claim 1, further comprising:
determining, by the computing device, if a prior partner profile exists for the business partner; and
generating, by the computing device, a partner profile for the business partner, prior to assigning the risk score to the business partner, when a prior partner profile does not exist.

8. The method of claim 7, wherein assigning a risk score to the business partner includes generating the risk score based, at least in part, on information included in the partner profile for the business partner.

9. The method of claim 7, wherein assigning a risk score to the business partner includes accessing a prior risk score for the business partner, when a prior partner profile does exist for the business partner.

10. The method of claim 1, further comprising assigning the sensitivity threshold to the requested product and/or service, prior to comparing the risk score assigned to the business partner to the sensitivity threshold associated with the requested product and/or service.

11. The method of claim 10, further comprising updating the sensitivity threshold assigned to the requested product and/or service periodically, intermittently, or based on at least one change to the product and/or service.

12. The method of claim 1, wherein the business partner includes a business partner of a payment network, and wherein the product and/or service includes a product and/or service offered by the payment network.

13. A system for authenticating a business partner prior to distributing a product and/or a service to the business partner, the system comprising:
a memory configured to store sensitivity thresholds for multiple products and/or services offered by a payment network to business partners, and profiles associated with the business partners, the profiles including prior risk scores assigned to the business partners;
at least one processor coupled to the memory, the at least one processor configured to:
search in the memory, in response to a request from a business partner for a product and/or service offered by the payment network, for a profile associated with the business partner;
when a profile is found in the memory, assign the prior risk score included in the memory, in association with the profile, to the business partner;
when a profile is not found in the memory, assign a new risk score to the business partner;
compare the assigned prior or new risk score to a sensitivity threshold associated with the requested product and/or service; and
distribute the product and/or service to the business partner, when the assigned prior or new risk score satisfies the sensitivity threshold.

14. The system of claim 13, wherein, when the prior risk score is assigned to the business partner, the at least one processor is further configured to:
update the prior risk score when the assigned prior risk score does not satisfy the sensitivity threshold;
compare the updated risk score to the sensitivity threshold associated with the requested product and/or service; and
distribute the product and/or service to the business partner, when the updated risk score satisfies the sensitivity threshold.

15. The system of claim 14, wherein the prior risk score, the new risk score, and/or the updated risk score are based on one or more of a risk assessment assigned to a business unit associated with the business partner, a risk assessment assigned to a business person associated with the business partner, a risk assessment assigned to an association between the business unit and the business person, and a rule and/or regulation implicated by a location associated with the business partner.

16. The system of claim 15, wherein the business partner is selected from a group consisting of an issuer, an acquirer, a merchant, and a consumer.

17. The system of claim 15, wherein the at least one processor is further configured to deny the request for the product and/or service to the business partner, when the assigned prior risk score, new risk score, or updated risk score fails to satisfy the sensitivity threshold.

18. A non-transitory computer-readable storage media including computer-executable instructions for authenticating a business partner prior to distributing a product and/or a service to the business partner, which when executed by at least one processor, cause the at least one processor to:
assign a risk score to a business partner in response to a request from the business partner for a product and/or service, the risk score selected from the group consisting of a new risk score generated after receipt of the request and a prior risk score generated before receipt of the request;
compare the assigned risk score to a sensitivity threshold associated with the requested product and/or service;
when the assigned risk score satisfies the sensitivity threshold, distribute the product and/or service to the business partner; and
when the assigned risk score does not satisfy the sensitivity threshold and is a prior risk score:
update the prior risk score;
compare the updated risk score to the sensitivity threshold associated with the requested product and/or service; and
distribute the product and/or service to the business partner when the assigned risk score satisfies the sensitivity threshold;
when the assigned risk score does not satisfy the sensitivity threshold and is a new risk score, deny the request for the product and/or service to the business partner.

19. The non-transitory computer-readable storage media of claim 18, wherein the business partner includes a business partner of a payment network, and wherein the product and/or service includes a product and/or service offered by the payment network.

20. The non-transitory computer-readable storage media of claim 18, wherein the computer-executable instructions, when executed by the at least one processor in connection with assigning a risk score to a business partner, further cause the at least one processor to generate the risk score based on one or more of a risk assessment assigned to a business unit associated with the business partner, a risk assessment assigned to a business person associated with the business partner, a risk assessment assigned to an association between the business unit and the business person, and a rule and/or regulation implicated by a location associated with the business partner.
